(19) United States
(12) Patent Application Publication
(10) Pub. No.: US 2005/0014523 A1
(43) Pub. Date: Jan. 20, 2005

(54) Apparatus, and an associated method, for facilitating power control in a radio communication system that provides for data communications at multiple data rates

(76) Inventors: Zhouyue Pi, Irving, TX (US); Vesa Petteri Luukkanen, Tupos (FI)

Correspondence Address: Robert H. Kelly;Scheef & Stone, L.L.P., Suite 1400, 5956 Sherry Lane, Dallas, TX, 75225, US

(21) Appl. No.: 10/861,900

(22) Filed: Jun. 4, 2004

Related U.S. Application Data
(60) Provisional application No. 60/478,455, filed on Jun. 13, 2003.

(30) Foreign Application Priority Data
Jun. 5, 2003 (WO) PCT/US03/17625

(51) Int. Cl. H04Q 7/20

(52) U.S. Cl. 455/522; 455/434

(57) ABSTRACT

Apparatus, and an associated method, for facilitating closed-loop power control in a radio communication system, such as upon reverse links defined in a CDMA2000, cellular communication system. Rate indications are modulated by a modulator upon a control channel carrier signal to form a modulated data segment. Then, the modulated data segment is repeated a selected number of times to form a concatenated sequence of modulated data segments. The modulated data segments are of sub-frame lengths and the concatenated sequences of a frame length. When the concatenated sequence is communicated and delivered to a communication station, the information contained in a sub-frame portion can be used to improve power control operations upon the reception of the sub-frame rather than waiting for an entire frame of information to be delivered to the communication station.

### CROSS-REFERENCE TO RELATED APPLICATIONS

The present application claims the priority of international patent application of Application Serial No. PCT/US03/17625, filed on Jun. 5, 2003, and upon U.S. provisional patent application of Serial No. 60/478,455, filed on Jun. 13, 2003, the contents of such applications are incorporated herein in their entireties.

The present invention relates generally to a manner by which to facilitate effectuation of closed-loop power control in a radio communication system, such as a cellular communication system that provides variable-rate communication services and is operable pursuant to a code-division, multiple-access communication scheme. More particularly, the present invention relates to apparatus, and an associated method, by which to populate successive sub-frame portions of a frame communicated on a reverse pilot, or other appropriate, control channel with rate indicator values.

The rate indicator values are used in closed loop power control operations, e.g., in inner-loop power control operations in a communication system that utilizes both inner and outer loop, closed-loop power control. Inner loop power control, utilizing rate indicator values, commences subsequent to decoding of a sub-frame. Receipt of, and decoding of, an entire frame of control information to obtain the rate indicator values is obviated. Instead, the power control using the rate indication values commences after only a fractional portion of a frame. Use of the rate indicator values for inner loop power control operations is thereby possible.

### BACKGROUND OF THE INVENTION

Many aspects of modern society require that communication systems be readily accessible by way of which to send data and to receive data. Many varied types of communication services are effectuable by way of various communication systems. And, as advancements in communication technologies permit, new communication services, as well as new communication systems to permit their effectuation, shall likely become available in the future.

A communication system is formed of a set of communication stations that includes, at a minimum, a sending station and a receiving station. The sending and receiving stations are interconnected by way of a communication channel. Data originated at, or otherwise provided to, the sending station is sent by the sending station upon the communication channel for delivery to the receiving station. The receiving station operates to detect the data communicated thereto and to recover the informational content thereof.

A radio communication system is a type of communication system. In a radio communication system, the communication channel that interconnects the sending and receiving stations is formed of a radio channel, defined upon a portion of the electromagnetic spectrum. Wireline communication systems require wirelines upon which to define the communication channels upon which data is communicated between the sending and receiving stations. The sending and receiving stations must be connected to the wirelines. And, to permit their connections to the wireline, the communication stations must be positioned at locations that are permitting of their connections to the wireline. In contrast, freed of the need to use wirelines, need not position the communication stations thereof at locations amenable to connection to wirelines. Communications by way of a radio communication system are, thereby, effectuable between locations at which use of a wireline communication system would not be possible. Additionally, a radio communication system is amenable for implementation as a mobile communication system.

A cellular communication system is an exemplary type of mobile radio communication system. Cellular communication systems of various constructions have been deployed throughout significant portions of the populated areas of the world and have achieved wide levels of usage. Telephonic communications are effectuable in a cellular communication system. Typically, a user communicates telephonically by way of a cellular communication system through the use of a mobile station.

While early-generation, cellular communication systems generally provided telephonic voice communication services and limited data communication services, subsequent generations of cellular communication systems provide for the effectuation of data communication services. And, effectuation of data communication services through the use of a cellular communication system is becoming increasingly pervasive.

An exemplary cellular communication system that permits the effectuation of data communication services is set forth in a CDMA2000 operating specification. And, standardization of the operating specification is ongoing. Various proposals pertaining to data communication services have been set forth. The 1xEV-DV data communication service and the 1xEV-DO is another data communication service that is, or is anticipated, to be available in CDMA2000 communication systems. Both of these data communication services provide for the communication of data at any of several selected data rates. This system, and others that operate analogously, are sometimes referred to as being multi-rate communication systems.

In a CDMA2000 system that provides for multi-rate communication services, data that is to be communicated can be communicated on reverse links. That is to say, data can be communicated by a mobile station to a network part of the communication system at a selected data rate of an available group of data rates. A pilot signal is also communicated by the mobile station to the network part of the communication system. The pilot signal is communicated upon a reverse pilot channel and the data is communicated upon a data channel. The pilot signal is used at the network part to facilitate coherent demodulation of the data that is communicated upon the data channel.

A significant aspect of a CDMA communication system is its use of closed-loop power control. For instance, with respect to reverse link communications, closed-loop power control is utilized to control the power levels at which reverse link signals are communicated. A base station, forming part of the network part of the communication system, operates to measure reverse link pilot channel strength and to compare the measured levels to an outer loop power control threshold. Responsive to the comparison, a determination is made to return a power-up or a power-down command to the mobile station. In existing schemes, a primary, reverse-link pilot channel is used for channel estimation and channel quality measurements that are required pursuant to closed-loop power control operation. The base station must know when the pilot signal power level is changed in order to determine correctly the outer loop power control threshold.

There is, however, no existing manner by which to alert the base station of this on a frame-by-frame basis. As the power level of the pilot signal is not able to be changed dynamically, depending upon the data, i.e., traffic, channel data rate, the level is selected according to a highest expected rate. And, as a result, the power level of the pilot signal is too high when data communicated on the traffic channel is less than a maximum data transmission rate. The excess pilot power introduces unnecessary potential interference to other communications effectuated in the communication system.

Proposals have been set forth by which to utilize an orthogonal secondary pilot channel to provide additional pilot power to support variable high rate traffic channels. A rate indicator that identifies the data transmission rate, is transmitted to indicate to the network part of the communication system the data rate of data communicated in a current frame, which also unambiguously identifies a secondary pilot channel power level relative to the power level of the primary pilot channel.

While this scheme is ably utilized to perform channel estimation, the extra pilot power levels cannot be used for inner-loop, closed-loop power control as, in conventional operation, an entire rate indicator frame must be received at the network part prior to performance of the coding operations and recovery of the value of the rate indicator.

Accordingly, there is a need to provide an improved manner by which to perform closed-loop power control in a multi-rate data communication system.

It is in light of this background information related to radio communication systems capable of communicating data at multiple data rates that the significant improvements of the present invention have evolved.

### SUMMARY OF THE INVENTION

The present invention, accordingly, advantageously provides apparatus, and an associated method, by which to facilitate effectuation of closed-loop power control in a radio communication system, such as a cellular communication system that provides variable-rate communication services and is operable pursuant to a CDMA communication scheme, such as that set forth in a CDMA2000 operating specification that provides for 1xEV-DV or 1xEV-DO data services.

Through operation of an embodiment of the present invention, a manner is provided by which to populate successive sub-frame portions of a frame communicated on a reverse pilot, or other appropriate control, channel. A frame, formed of a plurality of the sub-frames, each populated with the rate indicator value, is formed and caused to be transmitted by a mobile station upon the reverse pilot channel to a network part of the cellular communication system. Upon delivery and decoding of a sub-frame portion of the frame, the value of the rate indication is obtained, and used pursuant to power control operations.

Effectuation of inner-loop power control that takes into account rate indicator values is provided. The power control utilizing the rate indicator values commences subsequent to decoding of a sub-frame of the frame formed of the sub-frames populated with the rate indications. Indications of the values of the indicators are available upon receipt of a sub-frame. Receipt, and decoding, of an entire frame of control information is not needed to obtain and use the rate indicator values. Instead, power control is initiated responsive to detection and decoding of a sub-frame of the frame, thereby permitting initiation of power control using rate indication values as criteria for selection of power control values.

In one aspect of the present invention, rate indications that identify the rate at which data is communicated upon a data channel associated with a pilot, or other control, channel is formed of a multi-bit sequence, such as a four-bit sequence. The sequence forms a rate indicator value and is modulated upon a pilot-signal carrier, thereby to form a modulated data segment. The modulated data segment identifies the value of the rate indicator that identifies the data rate at which data is communicated upon the associated data channel. The data is communicated, for instance, upon a secondary data channel and the modulated data segment is modulated upon a secondary pilot signal. The modulated data segment is of a sub-frame length, i.e., is of a length that is a fractional portion of a frame defined pursuant to frame-formatting into which information communicated upon the secondary pilot channel is segmented.

In another aspect of the present invention, the modulated data segments, formed by modulating the rate indication values upon a carrier is repeated a selected number of times. For instance, when the modulated data segment is of a segment length of one-quarter of the length of the frame into which information communicated upon the secondary pilot channel is segmented, the modulated data segment is repeated four times to form a concatenated sequence of modulated data segments. A single frame of information communicated upon the reverse secondary pilot channel thereby is formed of four modulated data segments concatenated end-to-end. The rate indication value is able to be derived through appropriate analysis of any of the modulated data segments of the concatenated sequence.

In another aspect of the present invention, the concatenated sequence of modulated data segments is transmitted by the mobile station on the reverse secondary pilot, or other control, channel for delivery to a base station of a network part of the radio communication system in which the mobile station is operable. The base station detects delivery of the modulated data segments successively delivered to the base station. A decoder embodied at the base station, or elsewhere at the network part of the communication system, decodes the modulated data segments to obtain values of the rate indications modulated thereon. Because the rate indicator is contained in a fractional portion of the frame, i.e., contained in a modulated data segment that forms a fractional part of a frame, the decoder is able to derive the value of the rate indicator by decoding a single modulated data segment and does not require that an entire frame be delivered and decoded. Therefore, the value of the rate indicator is available for inner loop power control operations.

Power control that takes into account the data rate at which data is communicated upon an associated data channel is provided. The base station need not await the delivery of an entire frame to obtain a value of the rate at which the data is communicated on the associated data channel. But, rather, through decoding of a sub-frame portion of the frame, the value of the rate at which the data is communicated upon the associated data channel is derivable. Effectuation of the power control that takes into account the data rate at which the data is communicated on the associated data channel improves communications in the communication system by causing the power level at which the data is communicated upon the data channel to correspond to the appropriate power level for the data rate at which the data is communicated pursuant to inner-loop power control operations.

In these and other aspects, therefore, apparatus, and an associated method, is provided for a radio communication system. The radio communication system has a first communication station that is selectably operable to communicate values of control data on a control channel pursuant to a frame-formatted data communication scheme that defines frames. Each frame is of a selected frame length. Values of the control data are formed in a form to facilitate detection thereof when delivered to a second communication station. A modulator is adapted to receive indications of the values of the control data. The values of the control data, once modulated, form a modulated data segment. The modulated data segment is of a sub-frame length that corresponds to a sub-frame portion of the frame length of each of the frames. A repeater is coupled to receive the modulated data segment formed by the modulator. The repeater repeats the modulated data segment a selected number of times to form a concatenated sequence of modulated data segments.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a radio communication system in which an embodiment of the present invention is operable.

FIG. 2 illustrates a representation of data and pilot channels defined in the radio communication system shown in FIG. 1 and used during operation of the communication system.

FIG. 3 illustrates a representation corresponding to the time period of a single frame defined upon the pilot channels used pursuant to operation of the radio communication system shown in FIG. 1.

FIG. 4 illustrates a functional block diagram of portions of the radio communication system shown in FIG. 1.

FIG. 5 illustrates a method flow diagram of the method of operation of an embodiment of the present invention.

### DETAILED DESCRIPTION

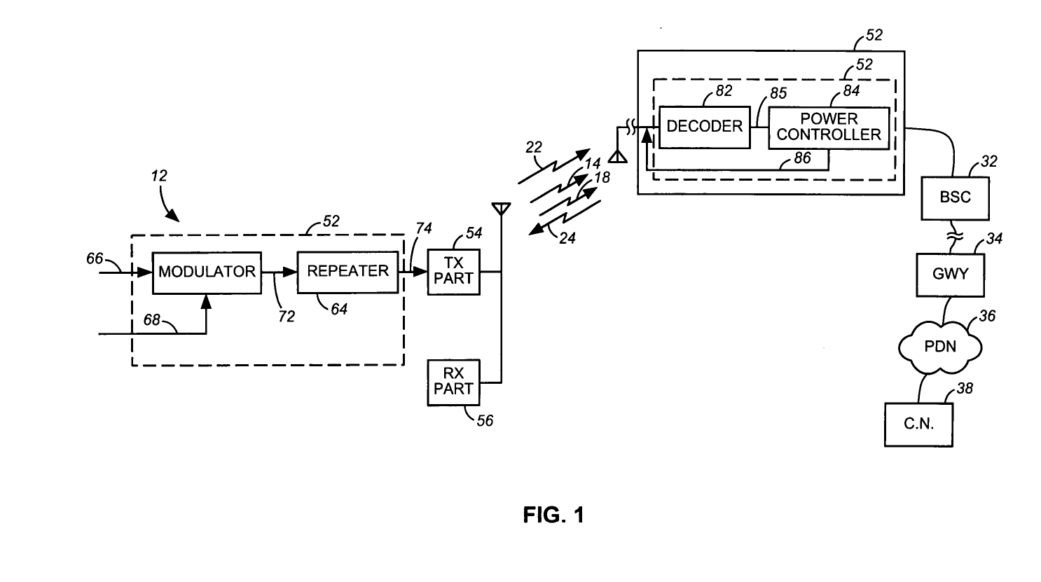

Referring first to FIG. 1, a radio communication system, shown generally at 10, provides for radio communications with mobile stations, of which the mobile station 12 is representative. The communication system provides for the effectuation of data communication services at multiple data rates. That is to say, communication services are effectuated at a selected data rate, selected from a plurality of different data rates. In the exemplary implementation, the communication system operates pursuant to an IS2000 operating specification, also referred to as a CDMA2000 operating specification, that provides for 1xEV-DV communication services.

The radio communication system is also representative of other types of cellular, and other radio, communication systems that provide for multiple data rate data communication services. Accordingly, while the following description of operation of an embodiment of the present invention shall be described with respect to its implementation in a CDMA2000/1xEV-DV-compliant communication system, an embodiment of the present invention is analogously also implementable in another type of radio communication system that provides for multiple data rate communication services.

The mobile station 12 communicates with a network part of the communication system by way of radio channels of a radio air interface defined between the network part and the mobile station. Data communicated by the network part to a mobile station is communicated upon forward link channels defined upon the radio air interface. And, data originated at the mobile station is communicated by way of reverse link channels defined upon the radio air interface. Both data and control channels are defined upon both the forward and reverse links.

The CDMA2000 operating specification defines various control and traffic channels along with the parameters of data communicated thereon. With respect to reverse-link communications, i.e., data communicated by the mobile station for delivery to the network part by way of reverse link channels, here a reverse packet data channel (R-PDCH) is defined and used upon which to communicate traffic data pursuant to effectuation of a data communication service. The arrow 14 is representative in the figure of reverse packet data channel. The channel is used, e.g., to communicate 1xEV-DV data at a selected data rate of a group of available data rates of which the mobile station is capable of operation. The data rates at which data is communicated upon the reverse packet data channel is changeable.

Reverse pilot and reverse secondary pilot channels (R-PICH and R-SPICH) are further defined. The arrow 18 is representative of the reverse pilot channel, and the arrow 22 is representative of the reverse secondary pilot channel. And, the arrow 24 is representative of forward link channels upon which traffic and control data is communicated.

Portions of the network part of the communication system are represented in the figure. A base station 26 forms part of the network part of the communication system. The base station includes transceiver circuitry capable of detecting data communicated upon the reverse-link traffic and control channels and to send data upon forward-link traffic and control channels. The base station, in turn, is coupled to a base station controller (BSC) 32. And, the base station controller is coupled, by way of a gateway (GWY) 34 to a packet data network (PDN) 36. A correspondent node (CN) 38 is coupled to the packet data network. The correspondent node is representative of any correspondent entity that forms a source or destination of data communicated pursuant to effectuation of a communication service. The correspondent node is, for instance, representative of a computer station, a telephonic station, or a content server.

During effectuation of a communication service, communication resources are allocated for the communication of the data upon the radio air interface pursuant to a communication session during which the communication service is effectuated. The power level at which data is communicated is related to the data rate at which the data is communicated. Generally, when data is communicated at a higher data rate, a higher power level is required to effectuate properly the communication of the data. In a communication system that utilizes code-division techniques, the power levels at which data is communicated must be closely controlled so that interference between concurrently-communicated data pursuant to separate communication sessions. Closed-loop power control means is utilized to control the power levels at which data is communicated during effectuation of a communication service in a CDMA2000-compliant communication system.

With respect to reverse-link communications, pilot signals are transmitted by the mobile station on the reverse pilot and reverse secondary pilot channels. Pilot signals are communicated together with communication of data on associated data channels to facilitate the coherent demodulation of the data communicated upon the data channels. The secondary pilot signal transmitted upon the reverse secondary pilot channel includes a rate indicator that indicates the rate at which the data is communicated upon the reverse packet data channel. Use of the rate indicator that indicates the rate at which the data is communicated to effectuate power control is unable to be used in conventional system operation pursuant to inner-loop power control as an entire frame that contains the rate indication must be delivered to the network part, and the frame must be decoded, prior to use of the rate indication pursuant to power control command generation at the network part of the communication system. The existing need to receive an entire frame prior to commencement of use of the rate indication delays effectuation of the power control.

Pursuant to an embodiment of the present invention, the mobile station 12 includes apparatus 52 of an embodiment of the present invention. The apparatus operates in a manner to facilitate early detection and use of the rate indication that indicates the communication rate at which data is communicated upon the supplemental channel so that the network part of the communication system is earlier able to use the rate indication pursuant to effectuation of closed-loop power control. The radio transceiver circuitry, here represented by a transmit part 54 and a receive part 56, of the mobile station is also shown.

The elements of the apparatus 52 are functionally represented and are implementable in any desired manner, such as by algorithms executable by processing circuitry. The apparatus here operates to form, on the line 58, a secondary pilot signal that is caused to be communicated by the transmit part of the mobile station upon the reverse-link secondary pilot channel 18 for delivery to the base station 26 of the network part. The base station includes further apparatus 52 of an embodiment of the present invention. The further apparatus 52 embodied at the base station is also represented functionally, and the elements of the apparatus embodied at the base station are also implementable in any desired manner, again such as by algorithms executable by processing circuitry.

The apparatus 52 embodied at the mobile station includes a modulator 62 and a repeater 64. The modulator is provided, by way of the line 66, a pilot carrier signal. And, the modulator is provided by way of the line 68, rate indicator bits, here a four-bit value that forms the rate indicator, the value of which identifies the data rate at which data is communicated upon the associated reverse packet data channel. The rate indicator bits are modulated upon the pilot carrier by the modulator and a modulated data segment is formed on the line 72. The modulated data segment is of a segment length of a duration of a sub-frame length of a frame into which data is formatted on the reverse link supplemental channel. That is to say, the modulated data segment is of a length that is a fraction of the length of the frame into which data communicated on the reverse supplemental channel is formatted. In the exemplary implementation, the modulated data segment is of a segment length of 2.5 ms duration.

The modulated data segment is provided to the repeater 64. The repeater operates to repeat the modulated data segment provided thereto and to form, on the line 74, a concatenated sequence of a selected number of modulated data segments. In the exemplary implementation, the repeater repeats the modulated data segment so that the concatenated sequence is formed of four modulated data segments, each of 2.5 ms segment durations and the concatenated sequence of a 2.5 ms duration. The concatenated sequence is provided to the transmit part 54 and caused to be transmitted therefrom upon the reverse secondary pilot channel.

The further apparatus 52 embodied at the base station 28 includes a decoder 82 and a power controller 84. The decoder decodes the individual sub-frames of the concatenated sequence of the modulated data segments. And, upon decoding of a sub-frame, an indication of the value thereof is provided to the power controller 84 by way of the line 85 and is used, e.g., together with other indicia, to generate power control bits, here formed on the line 86 for return pursuant to closed-loop control to the mobile station. The values of the power control bits cause the power levels at which the data communicated upon the supplemental pilot channel to be increased or decreased incrementally. The values on the line 85 are used pursuant to inner-loop power control procedures by which to, e.g., adjust a threshold level responsive to which decisions are made of what the values of the power control bits are to be. Because the power control is effectuated upon delivery to the base station of nearly a sub-frame of data on the supplemental pilot channel, power control is more quickly effectuated. Improved communication performance in the communication system is thereby possible.

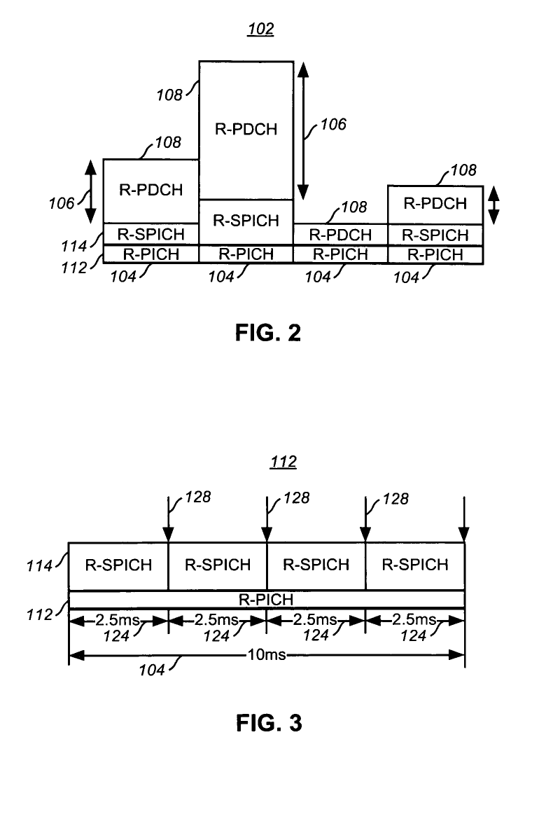

FIG. 2 illustrates a representation, shown generally at 102, of exemplary data communications during operation of the radio communication system 10, shown in FIG. 1, at successive time periods 104. The amounts of data communicated upon the reverse data channels (R-PDCH) at different ones of the time periods 104 are represented by the heights 106 of the blocks R-PDCH 108 at the different ones of the time periods. The signal-to-noise levels of reverse pilots and reverse secondary pilot signals generated on the reverse pilot and reverse supplemental pilot channels at the different time periods 104 are represented by the blocks 112 and 114, respectively. The level of the reverse-link pilot signal is constant, but the level of the reverse-link secondary pilot channel varies according to the amount of data communicated on the reverse packet data channel. As the amount of data communicated on the reverse data channel changes, the power level of the secondary pilot signal communicated on the supplemental pilot channel correspondingly changes. To utilize the pilot power of the pilot and secondary pilot signals in optimal manner, the ratio between the pilot and secondary pilot signals must be known. The ratio is derivable from the rate indicator of an ongoing communication of a data frame communicated on the data channel. If the rate indicator is sent in parallel with the frame of data, the information is ascertainable at the base station only after the rate indicator is completely received. Inner-loop power control cannot be performed by taking into account the rate indicator value when sent concurrently.

Operation of the apparatus 52 provides a manner by which to decode, and make use of, values of the rate indicator without requiring that an entire frame of data be received prior to decoding of the rate indicator value.

FIG. 3 illustrates a representation, shown generally at 122, that shows, during successive sub-frames 124 of a time period 104, the power levels at which pilot and secondary pilot signals are sent on the reverse pilot and reverse supplemental pilot channels, respectively. The pilot and secondary pilot signals are again represented by the blocks 112 and 114. At the conclusion of each sub-frame, the base station apparatus extracts the rate indications contained in the sub-frame just-delivered and uses the extracted information pursuant to inner-loop power control operations. The rate indicator information is obtainable subsequent to receipt of a first sub-frame portion of a frame, thereby to permit earlier use of the rate indication values pursuant to power control operations. And, because the rate indicator is contained in each sub-frame of a concatenated sequence delivered to the base station, corresponding excessive extractions, indicated at the times 128, permit the rate indicator to be extracted a multiple number of times, and the reliability of the values of the rate indicators improves with successive extraction and decoding operations performed on the successive sub-frames.

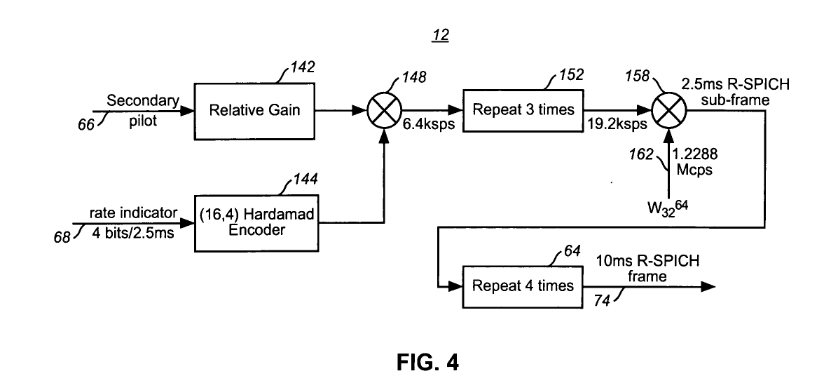

FIG. 4 illustrates portions of the radio communication system 10 shown previously in FIG. 1. Portions of the mobile station 12 are shown. Here, the secondary pilot carrier signal generated on the line 66 is first amplified by the relative gain element 142, and the rate indicator bits generated on the line 68 are first encoded by a Hardamad encoder 144.

The encoded rate indications and secondary pilot signal are mixed by a mixer 148, and the mixed signal is repeated by a first repeater 152. The repeater converts a 6.4 ksps duration into a 19.2 ksps duration.

Then, the repeated value is mixed by a mixer 158. The mixer also receives, on the line 162, a spreading code. Once mixed, the rate indication values are of a length of 1.2288 Mcps. The mixed values are provided to the repeater 64 that repeats the values provided thereto four times to form the 10 ms concatenated sequence that is provided by way of the line 74 to the transmit part 54.

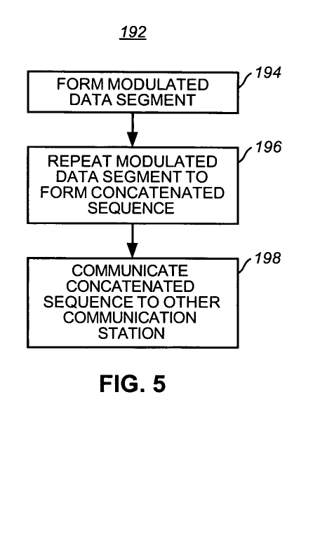

FIG. 5 illustrates a method flow diagram, shown generally at 192. The method facilitates the detection of control data communicated by the first communication station of a radio communication system to a second communication station upon a control channel. The control data is communicated on the control channel pursuant to a frame-formatted data communication scheme that defines frames. Each frame is of a selected frame length.

First, and as indicated by the block 194, indications of values of the controlled data is modulated to form a modulated data segment. The modulated data segment is of a sub-frame length that corresponds to a sub-frame portion of the frame length of each of the frames.

Then, and as indicated by the block 196, the modulated data segment is repeated a selected number of times. Once repeated, a concatenated sequence of modulated data segments is formed.

Then, and as indicated by the block 198, the concatenated sequence is communicated to the second communication station for decoding and use of the values of the control data pursuant to power control operations.

Because the values of the control data are able to be earlier-used, power control is able to be effectuated taking into account the values of the control data. Improved communication performance of the communication system is provided.

The previous descriptions are of preferred examples for implementing the invention, and the scope of the invention should not necessarily be limited by this description. The scope of the present invention is defined by the following claims.

1. Apparatus for a radio communication system having a first communication station selectably operable to communicate values of control data on a control channel pursuant to a frame-formatted data communication scheme that defines frames, each frame of a selected frame length, said apparatus for forming the values of the control data in a form to facilitate detection thereof when delivered to a second communication station, said apparatus comprising:
a modulator adapted to receive indications of the values of the control data, the values of the control data, once modulated, forming a modulated data segment, the modulated data segment of a sub-frame length corresponding to a sub-frame portion of the frame length portion of the frame length of each of the frames; and
a repeater coupled to receive the modulated data segment formed by said modulator, said repeater for repeating the modulated data segment a selected number of times to form a concatenated sequence of modulated data segments.

2. The apparatus of claim 1 wherein the first communication station is further selectably operable to communicate communication data on a data channel, the communication data communicated on the data channel at a selected data rate, and wherein the control data, values of which are modulated by said modulator, are of values responsive to the selected data rate at which the communication data is communicated.

3. The apparatus of claim 2 wherein the communication data, communicated upon the data channel, and the control data, modulated by said modulator, repeated by said repeater, and communicated upon the control channel, are communicated in parallel.

4. The apparatus of claim 3 wherein the control data communicated upon the control channel identify data rates at which the communication data, communicated in parallel therewith, is communicated.

5. The apparatus of claim 1 wherein the radio communication system comprises a cellular communication system operable pursuant to a code-division communication scheme, wherein the data channel comprises a supplemental pilot channel, and wherein said modulator modulates the control data for communication thereof upon the supplemental pilot channel.

6. The apparatus of claim 2 wherein the second control data, modulated by said modulator, comprises a rate indication value that identifies the selected data rate at which the communication data is communicated upon the communication data channel.

7. The apparatus of claim 1 wherein the concatenated sequence of modulated data segments formed by said repeater is of a sequence-length no greater than the selected frame length of each frame defined pursuant to the frame-formatted data communication scheme.

8. The apparatus of claim 7 wherein the selected frame length defined pursuant to the frame-formatted data communication scheme is of approximately a ten millisecond duration and wherein the sub-frame length of the modulated data segment formed by said modulator comprises a fractional portion of the ten millisecond duration of the selected frame length.

9. The apparatus of claim 8 wherein the concatenated sequence of modulated data segments is formed by repeating the modulated data segment four times.

10. The apparatus of claim 1 wherein the control data is of multiple-bit lengths and wherein said modulator modulates the multiple-bit lengths of the control data onto a channel carrier signal.

11. The apparatus of claim 1 wherein said apparatus further comprises a transmitter adapted to receive the modulated data segment, said transmitter for transmitting the modulated data segment to the second communication station.

12. The apparatus of claim 11 further comprising a receiver embodied at the second communication station, said receiver for receiving the concatenated sequence of modulated data segments transmitted thereto by said transmitter.

13. The apparatus of claim 12 further comprising a power control command generator adapted to receive indications of the concatenated sequence of the modulated data segments received by said receiver, said power control command generator for generating a power control command responsive to values of at least one of the modulated data segments of the concatenated sequence.

14. The apparatus of claim 13 further comprising a decoder coupled to said receiver and adapted to receive values of the concatenated sequence received thereat, said decoder for decoding at least successive ones of the modulated data segments forming the concatenated sequence, the indications of the concatenated sequence of which said power control command generator is adapted to receive comprise decoded representations formed by said decoder.

15. The apparatus of claim 14 wherein each of the successive ones of the modulated data segments decoded by said decoder is decoded during a decoder interval and wherein said power control command generator generates a power control command responsive to decoded representations formed by said decoder subsequent to a first decoder interval.

16. A method for facilitating detection of control data communicated by a first communication station of a radio communication system to a second communication station upon a control channel, the control data communicated on the control channel pursuant to a frame-formatted data communication scheme that defines frames, each frame of a selected frame length, said method comprising the operations of:
modulating indications of values of the control data to form a modulated data segment of a sub-frame length corresponding to a sub-frame portion of the frame length of each of the frames; and
repeating the modulated data segment a selected number of times to form a concatenated sequence of modulated data segments.

17. The method of claim 16 further comprising the operations of:
transmitting the concatenated sequence of the modulated data segments to the second communication station; and
detecting the concatenated sequence of the modulated data segments at the second communication station.

18. The method of claim 17 further comprising the operation of decoding successive modulated data segments of the concatenated sequence of the modulated data segments.

19. The method of claim 18 further comprising the operation of generating a power control command responsive to decoding, during said operation of decoding, of a selected modulated data segment of the concatenated sequence.

20. The method of claim 19 wherein each modulated data segment is decoded during a decoding period, and wherein the power control command, generated responsive to the decoding of the selected modulated data segment, is generated at least subsequent to a first decoding period.
